(19) United States
(12) Patent Application Publication
(10) Pub. No.: US 2025/0190151 A1
(43) Pub. Date: Jun. 12, 2025

(54) IMAGE PROCESSING APPARATUS, CONTROL METHOD FOR IMAGE PROCESSING APPARATUS, AND STORAGE MEDIUM

(71) Applicant: CANON KABUSHIKI KAISHA, Tokyo (JP)

(72) Inventor: TAKESHI SUZUKI, Tokyo (JP)

(21) Appl. No.: 18/973,670

(22) Filed: Dec. 9, 2024

(30) Foreign Application Priority Data
Dec. 11, 2023 (JP) 2023-208657

(51) Int. Cl. G06F 3/12

(52) U.S. Cl. CPC G06F 3/1204; G06F 3/1238; G06F 3/126

(57) ABSTRACT

An image processing apparatus having a plurality of home screens, includes a reception unit configured to receive job information about a job based on a job setting set on an information processing apparatus, and an acceptance unit configured to accept, based on a fact that the job information received by the reception unit includes start condition information that is information relating to a home screen among the plurality of home screens and indicating a condition for starting processing based on the job information, an input of start condition information.

### BACKGROUND

### Field of the Disclosure

The present disclosure relates to an image processing apparatus, a control method for the image processing apparatus, and a storage medium.

### DESCRIPTION OF THE RELATED ART

In image processing apparatuses for office use, a technique of performing reservation processing has been used to reserve job information (job) received from a terminal apparatus (e.g., personal computer (PC)) in an image processing apparatus. Examples of the reservation processing include reservation print processing by which job processing is started in response to authentication processing performed by a printing apparatus that has received a print job with a user name and the like added to the print job. With a spread of teleworking, there are more opportunities of printing work-related documents at home, and there may be an increasing demand for the reservation processing even by the image processing apparatus at home.

Japanese Patent Application Laid-open No. 2017-24261 discusses a technique of automatically printing, in a case where the user performs a login operation on a printing apparatus, a reserved document of a group to which a user belongs.

### SUMMARY

The present disclosure is directed to a technique for improving convenience for users of an image processing apparatus in a case where reservation processing is performed.

According to an aspect of the present disclosure, an image processing apparatus having a plurality of home screens, includes a reception unit configured to receive job information about a job based on a job setting set on an information processing apparatus, and an acceptance unit configured to accept, based on a fact that the job information received by the reception unit includes start condition information that is information relating to a home screen among the plurality of home screens and indicating a condition for starting processing based on the job information, an input of start condition information.

Further features of the present disclosure will become apparent from the following description of exemplary embodiments with reference to the attached drawings.

### BRIEF DESCRIPTION OF THE DRAWINGS

FIG. 1 is a block diagram illustrating a system configuration of a printing system.

FIG. 2 is a diagram illustrating a standard home screen displayed on an operation display unit.

FIGS. 3A and 3B are diagrams each illustrating a custom home screen displayed on the operation display unit.

FIG. 4 is a diagram illustrating a lock screen of a custom home screen displayed on the operation display unit.

FIG. 5 is a diagram illustrating a custom home screen displayed on the operation display unit after a lock is released.

FIG. 6 is a flowchart illustrating an unlocking sequence of the custom home screen.

FIG. 7 is a flowchart illustrating a locking sequence of the custom home screen that is performed by a tab operation.

FIG. 8 is a diagram illustrating screen transitions of a display screen.

FIG. 9 is a sequence diagram illustrating a sequence of a whole printing operation that is performed in the printing system.

FIG. 10 is a diagram illustrating an example of a tab information acquisition request command that is used in the printing system.

FIG. 11 is a diagram illustrating an example of a tab information acquisition response command that is used in the printing system.

FIG. 12 is a diagram illustrating a screen that is displayed on a terminal apparatus when a print job is generated.

FIG. 13 is a flowchart illustrating processing that is performed by the terminal apparatus when a print job is generated.

FIG. 14 is a diagram illustrating an example of a print job command that is used in the printing system.

FIG. 15 is a flowchart illustrating processing that is performed by a printing apparatus when the print job is received.

FIG. 16 is a diagram illustrating an example of a print job completion notification command that is used in the printing system.

### DESCRIPTION OF THE EMBODIMENTS

Hereinafter, the present disclosure will be described in detail with reference to the drawings. The following exemplary embodiments do not limit the present disclosure according to the scope of the claims, and not all combinations of features described in the exemplary embodiments are necessarily essential to the solving means of the present disclosure. In the accompanying drawings, the same or similar components are denoted by the same reference numerals, and redundant description will be omitted.

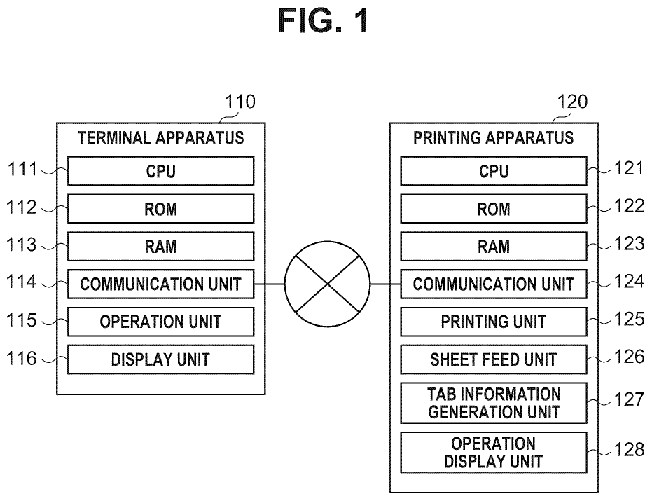

FIG. 1 is a block diagram illustrating a system configuration of a printing system according to an exemplary embodiment of the present disclosure. The printing system according to the present exemplary embodiment includes a terminal apparatus 110 that generates a job, and a printing apparatus 120 that consumes (processes) the job. The configuration is not limited thereto, and various kinds of information processing apparatuses, such as a personal computer (PC), a smartphone, and a digital camera, are applicable as the terminal apparatus 110 according to the present exemplary embodiment. The printing apparatus 120 indicates an image processing apparatus including a recording apparatus having a printing function for recording information on a printing medium using a recording material. For example, the printing apparatus 120 may be configured as a copying machine additionally including a reading apparatus for reading an image on a document, or a multifunction peripheral (MFP) including another function. Further, for example, various kinds of apparatuses, such as a PC, a smartphone, and a digital camera, may be applied as the printing apparatus 120 according to the present exemplary embodiment. The printing method of the printing apparatus 120 that is used in the present exemplary embodiment may be an electrophotographic method, inkjet method, or another method.

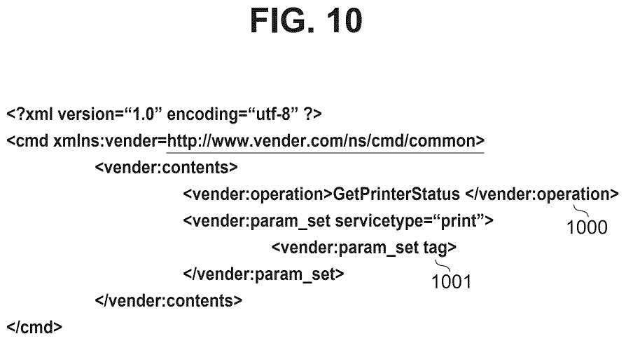

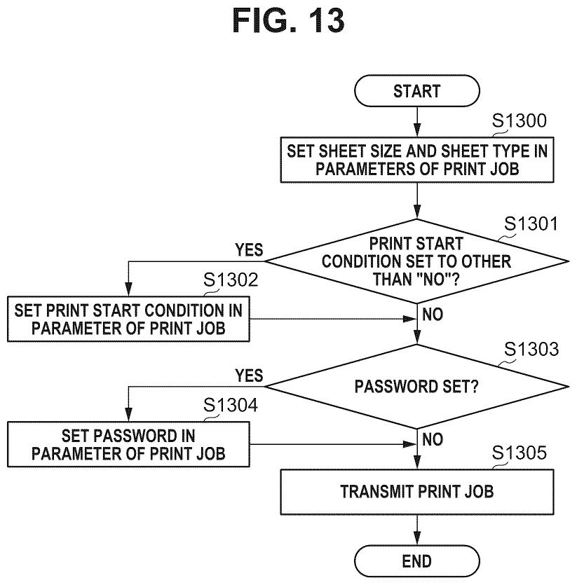

The terminal apparatus 110 includes a central processing unit (CPU) 111, a read only memory (ROM) 112, a random access memory (RAM) 113, a communication unit 114, an operation unit 115, and a display unit 116. The CPU 111 generates a job, such as a print job, by loading a program stored in the ROM 112 into the RAM 113, and executing the loaded program. In the present exemplary embodiment, the job generated by the terminal apparatus 110 and processed by the printing apparatus 120 is described as a print job, but the print job is not limited to such a print job. For example, the job may be any job as long as the job is able to be reserved, such as a scan job, and to which the present exemplary embodiment is applicable. Setting information to be used for generation of a print job is input by a user using a screen displayed on the display unit 116, and the operation unit 115. The terminal apparatus 110 acquires tab information or the like, among pieces of setting information to be used for generation of a print job, from the printing apparatus 120 connected via the communication unit 114. Processing of acquiring the information to be used for generation of the print job from the printing apparatus 120 will be described below with reference to FIG. 10. The generated print job is recorded in the RAM 113 and transmitted to the printing apparatus 120 connected via the communication unit 114. The print job generation processing will be described below with reference to FIG. 13. The communication unit 114 and the printing apparatus 120 are connected to each other using a known method, such as HyperText Transfer Protocol (HTTP) and Internet Printing Protocol (IPP). While, in the present exemplary embodiment, an interface (I/F) and a connection form of the communication unit 114 are not specifically prescribed, data may be transmitted and received via, for example, a wireless local area network (LAN). While, processing relating to the terminal apparatus 110 is executed by a vendor driver operable in the terminal apparatus 110 that is capable of communicating with the printing apparatus 120, for example, the communication may be executed by a predetermined application program operable in the terminal apparatus 110 that is capable of communicating with the printing apparatus 120. The predetermined application program is, for example, an application program capable of generating a print job and instructing the execution of the print job, and generating a scan job and instructing the execution of the scan job.

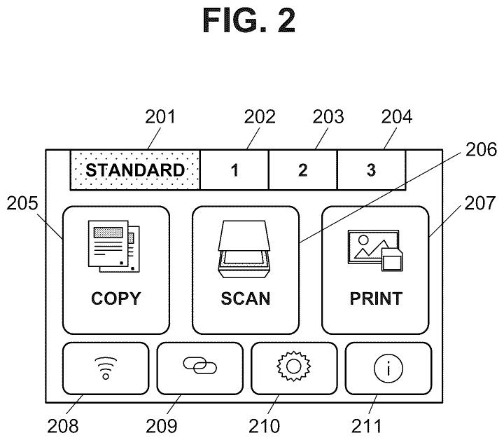

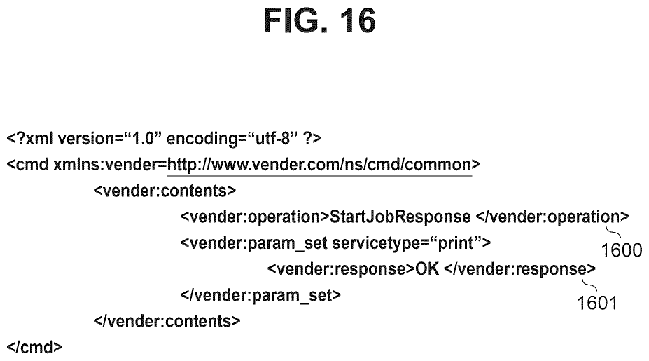

The printing apparatus 120 includes a CPU 121, a ROM 122, a RAM 123, a communication unit 124, a printing unit 125, a sheet feed unit 126, a tab information generation unit 127, and an operation display unit 128. The CPU 121 loads a program stored in the ROM 122 into the RAM 123, and executes the loaded program, whereby the printing apparatus 120 returns a response to a tab information acquisition request or consume a print job. In a case where the printing apparatus 120 receives a tab information acquisition request from the terminal apparatus 110 via the communication unit 124, the tab information generation unit 127 generates information about a current tab of the printing apparatus 120 by the tab information generation unit 127 to send a response to the terminal apparatus 110. The CPU 121 acquires print setting information to be used for consumption of the print job by using an analysis program stored in the ROM 122. The printing apparatus 120 determines whether to immediately perform printing or to perform reservation printing, according to the print setting information, such as tab information and password information. The determination processing will be described below with reference to FIG. 16. The operation display unit 128 has a tab form screen. The tab form screen will be described below with reference to FIGS. 2 to 8. In a case where a print condition is satisfied, the printing apparatus 120 determines a printing medium, acquires the printing medium from the sheet feed unit 126, and the printing unit 125 performs print processing.

In the printing system illustrated in FIG. 1, the printing apparatus 120 is wirelessly connected to the terminal apparatus 110 via a bi-directional interface (e.g., universal serial bus (USB) and Transmission Control Protocol/Internet Protocol (TCP/IP)). The communication method that is used for connection of apparatuses is based on, for example, communication standards of Institute of Electrical and Electronics Engineers (IEEE) 802.11 series (Wi-Fi) or Bluetooth® (Bluetooth® Classic and Bluetooth® Low Energy (BLE)). In the printing system according to the present exemplary embodiment, the apparatuses may be directly connected, or the communications between the apparatuses may be performed by Internet communications via a wireless LAN router.

The apparatuses may communicate using mobile communications (3rd Generation Mobile Communication System (3G), 4G, or 5G).

FIG. 2 is a diagram illustrating a standard home screen that is displayed on the operation display unit 128. A tab 201 is a tab corresponding to the standard home screen. Tabs 202, 203, and 204 are tabs each corresponding to a custom home screen. A user can switch the home screens by pressing a tab. The tab color of the tab 201 is differentiated from the other tabs to indicate that the screen corresponding to the tab 201 (i.e., standard home screen) is currently displayed. The standard home screen includes a copy menu button 205, a scan menu button 206, a print menu button 207, a LAN button 208, a wireless connection button 209, a setting button 210, and a hint button 211. In response to a user pressing any of the buttons, the screen transitions to a screen corresponding to the pressed button. More specifically, for example, in response to the copy menu button 205 being pressed, a screen including areas for an input of copy settings and for issuance of an execution instruction of a copy are displayed. Different from the custom home screens described below, predetermined buttons which are not arbitrarily selected by a user are displayed on the standard home screen. The configuration is not limited to this form, and the buttons that are displayed on the standard home screen may be arbitrarily selectable or changeable by a user. Software keys (softkeys), such as the tabs 202, 203, and 204, which are areas to be used for switching the custom home screens, may not be tabs. For example, the softkeys indicating respective custom home screens are displayed on a screen on which a user can switch the custom home screens, and in response to any one of the softkeys being selected, the custom home screen corresponding to the selected softkey may be displayed. While, in the present exemplary embodiment, numbers “1”, “2”, and “3” are displayed on the tabs 202, 203, and 204, respectively, as names, the configuration is not limited thereto. For example, instead of the numbers “1”, “2”, and “3”, names indicating persons who use the respective tabs, such as “Farther”, “Mother”, and “Child”, may be used, or names indicating the attributes of contents (intended uses) of the tabs, such as “Work”, “Study”, and “Hobby”, may be used. A user can change the names of the tabs using the operation display unit 128, and the changed names are stored in the RAM 123.

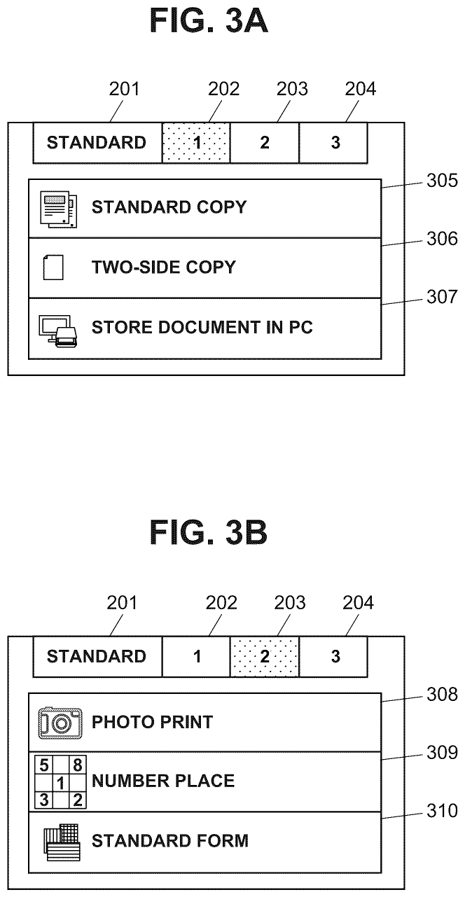

FIG. 3A is a diagram illustrating the custom home screen corresponding to the tab 202 that is displayed on the operation display unit 128. The color of the tab 202 is differentiated from the colors of the other tabs to indicate that the custom home screen corresponding to the tab 202 is currently displayed. The custom home screen corresponding to the tab 202 includes custom menus 305, 306, and 307 which are customizable by a user, and the user can designate functions to be displayed on the respective menus. In FIG. 3A, “Standard Copy” is set on the custom menu 305, “Two-Side Copy” is set on the custom menu 306, and “Store Document in PC” is set on the custom menu 307. Different from the standard home screen, menus associated with processing to be executed from each menu are registered to the custom home screen. More specifically, for example, in copying that is executed from the copy menu button 205, a setting of whether the copy is to be performed in two-side copy or one-side copy is additionally performed after the copy menu button 205 is pressed. On the other hand, in copying that is executed from the custom menu 306, a setting of whether the copy is to be performed in two-side copy or one-side copy is not additionally performed after the custom menu 306 is pressed. Login information or cookie information may be associated with each home screen and stored. Each custom home screen has a lock function setting to set a lock function (lock). In the lock function setting, whether to enable or disable the lock for each custom home screen is settable, and a password to release the lock is also settable. The lock in the present exemplary embodiment indicates a control by which the custom home screen is not displayed without inputting a correct password to a password input screen. In a case of the custom home screen without the setting of the lock, in response to a tab corresponding to a custom home screen being operated, the custom home screen is displayed without displaying the password input screen. The custom menu setting and the lock setting for the custom home screen is performed from the setting button 210 in FIG. 2.

FIG. 3B is a diagram illustrating a custom home screen corresponding to the tab 203, displayed on the operation display unit 128. The custom home screen corresponding to the tab 203 includes custom menus 308, 309, and 310, and the menus are customizable by a user, and the user can designate functions to be displayed on the respective menus. In FIG. 3B, “Photo Print” is set on the custom menu 308, “Number Place” is set on the custom menu 309, and “Standard Form” is set on the custom menu 310.

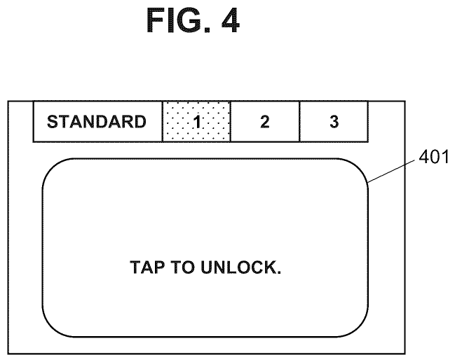

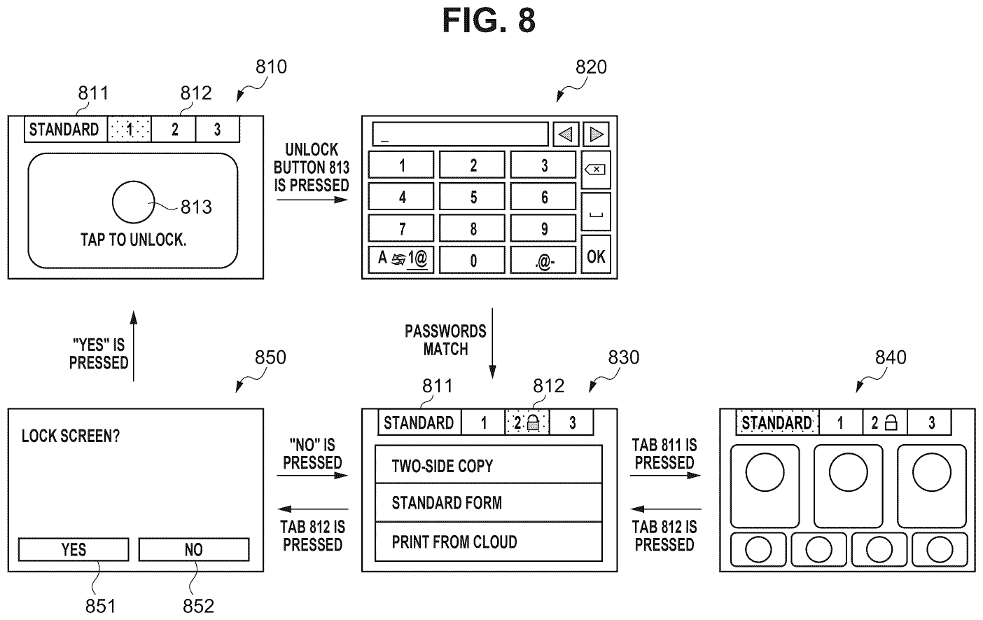

FIG. 4 is a diagram illustrating a lock screen of the tab 202 displayed on the operation display unit 128. In response to a user selecting the tab 202 corresponding to the locked custom home screen, the custom home screen is not displayed, and the screen illustrated in FIG. 4 is displayed. A password input screen is displayed in response to a user pressing an area 401 including an unlocking button, and in a case where the input password matches the correct password, the custom home screen corresponding to the tab 202 is displayed. The correct password is settable for each tab. A specific description is given below with reference to FIG. 8.

In the present exemplary embodiment, in a case where the tab 202 is pressed again after another tab menu is displayed from the currently displayed custom home screen corresponding to the tab 202, the custom home screen corresponding to the tab 202 is displayed without displaying of the lock screen and inputting of password by the user.

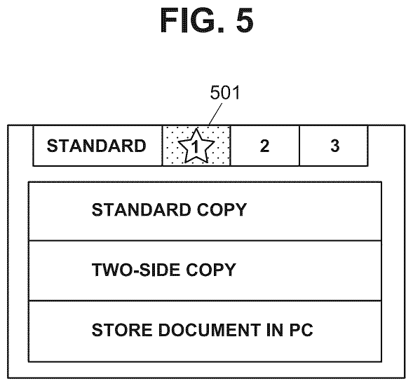

FIG. 5 illustrates a custom home screen in an unlocked state displayed on the operation display unit 128. An unlocked state icon 501 indicates that the lock setting of the currently displayed custom home screen corresponding to the tab 202 is released.

In the present exemplary embodiment, a user can lock the tab by pressing the unlocked state icon 501 (i.e., tab 202 in FIG. 5). The unlocked state icon 501 is not displayed on the lock setting disabled tab, and the processing is not performed even in a case where the user presses the tab corresponding to the currently displayed custom home screen. In the present exemplary embodiment, whether the tab lock setting is enabled or disabled is set for each tab in advance. The setting of whether the tab lock setting is enabled or disabled may be performed from the setting button 210, for example.

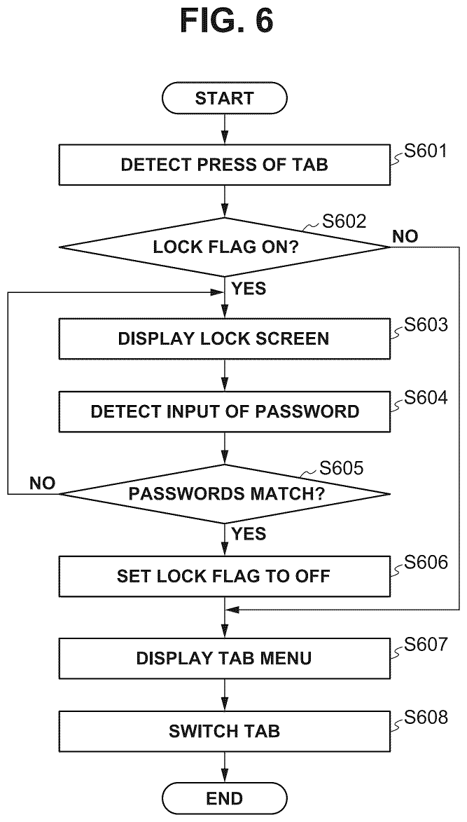

FIG. 6 is a flowchart illustrating an unlocking sequence according to the present exemplary embodiment. With reference to FIG. 6, a processing flow that is performed when a user unlocks a tab will be described. A series of the processing illustrated in this flowchart is performed by the CPU 121 of the printing apparatus 120 loading a program code stored in the ROM 122 into the RAM 123 and executing the loaded program code.

This processing is executed when a user presses a tab corresponding to a custom home screen. This processing starts in response to the operation display unit 128 detecting a user's operation such as a touch.

First, in step S601, the CPU 121 detects a tab pressed by the user.

In step S602, the CPU 121 determines whether a lock flag of the tab is ON. The lock flag of the tab acquirable from the RAM 123 is individually prepared for each tab, and turns to ON in response to a tab lock operation. Details of the tab lock operation will be described below. In a case where the lock flag is OFF (NO in step S602), the processing proceeds to step S607. In step S607, the CPU 121 displays a menu corresponding to the tab. The tab lock flag with the lock setting disabled is always OFF. As also described above, whether the tab lock setting is enabled or disabled is set for each tab in advance.

In a case where the lock flag is ON (YES in step S602), the processing proceeds to step S603. In step S603, the CPU 121 displays the lock screen illustrated in FIG. 4. In step S604, the CPU 121 detects a password input from the user. In step S605, the CPU 121 determines whether the input password matches the correct password. In a case where the input password does not match the correct password (NO in step S605), the processing returns to step S603. In step S603, the CPU 121 displays the lock screen again. In a case where the input password matches the correct password (YES in step S605), the processing proceeds to step S606. In step S606, the CPU 121 sets the lock flag to OFF. Then, in step S607, the CPU 121 displays the menu corresponding to the tab.

In step S608, in a case where the tab is switched to another tab by the user's operation, the CPU 121 keeps the state of the lock flag of the tab of the custom home screen displayed before the switching, which has been turned OFF in step S606, to be OFF. In this way, in a case where the CPU 121 detects that the tab is pressed again in step S601, in step S602, the CPU 121 determines that the lock flag of the tab is OFF (NO in step S602), and the user can display the tab menu without inputting the password. The above described is the flow of the processing that is performed in releasing of the tab lock.

Processing that is performed when a user locks a tab will be described.

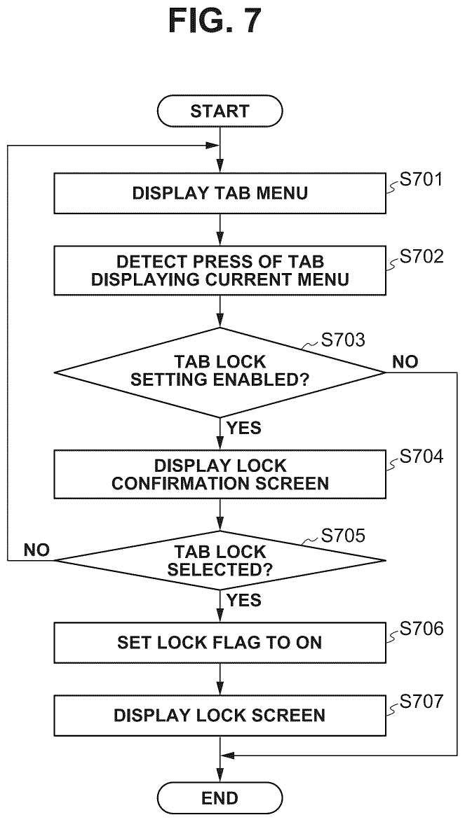

FIG. 7 is a flowchart illustrating a processing sequence that is performed when a user locks a tab. A series of processing illustrated in this flowchart is performed by the CPU 121 of the printing apparatus 120 loading a program code stored in the ROM 122 into the RAM 123 and executing the loaded program code. This processing starts in response to a tab being changed to an unlocked state by a user's unlocking operation, such as a password authentication.

In step S701, the CPU 121 displays a menu corresponding to a tab on the operation display unit 128. In step S702, the CPU 121 detects pressing performed on the tab displaying the current menu on the operation display unit 128. In step S702, in a case where the CPU 121 has not detected the pressing performed on the tab, for example, until the time when a predetermined time has elapsed, this processing ends. On the other hand, in a case where the CPU 121 has detected the pressing performed on the tab within the predetermined time, the processing proceeds to step S703. In step S703, the CPU 121 determines whether the lock setting of the tab is enabled. As is described above, in the present exemplary embodiment, whether the tab lock setting is enabled or disabled is set for each tab in advance. In a case the lock setting of the tab is disabled (NO in step S703), the processing ends. In a case where the lock setting of the tab is enabled (YES in step S703), the processing proceeds to step S704. In step S704, the CPU 121 displays a lock confirmation screen. For example, the lock confirmation screen is a display screen 850 in FIG. 8. Then, the user selects whether to lock the tab on the lock confirmation screen.

In a case where the CPU 121 detects that the user has performed a selection by the user's operation not to lock the tab on the lock confirmation screen (NO in step S705), the processing returns to step S701. In step S705, in a case where the CPU 121 detects that the user has performed a selection to lock the tab (YES in step S705), the processing proceeds to step S706. In step S706, the CPU 121 sets the lock flag to ON. In step S707, the CPU 121 displays the lock screen, and ends the processing of this flowchart. The above described is the flow of the processing that is performed in the case where the user locks the tab.

The series of flow of the tab lock and unlock described above with reference to FIGS. 6 and 7 will be described with reference to screens that is displayed on the operation display unit 128.

FIG. 8 is a diagram illustrating transitions of the display screen in locking and unlocking of the tab. A display screen 810 is a display screen displayed in response to a user pressing a tab 812 with the lock flag being ON. The display screen 810 is a screen corresponding to steps S601 to S603 in the flowchart in FIG. 6. On the display screen 810, in response to a user pressing an unlock button 813, a display screen 820 serving as a password input screen is displayed. In response to the user inputting a correct password, a display screen 830 is displayed. The display screen 830 is a display screen corresponding to the tab 812, and also corresponding to step S607 in FIG. 6. Further, on the display screen 830, a mark indicating an unlocked state is displayed on the tab 812.

In response to the user pressing a tab 811 serving as a standard tab on the display screen 830 corresponding to the tab 812, a standard home screen 840 is displayed. In this processing, the state of the tab 812 which is in the unlocked state is maintained in the unlocked state. In response to the user pressing the tab 812 again after finishing operation on the standard home screen 840, the display screen 830 is displayed without the user's unlocking operation. In this processing, in response to the user pressing the tab 812 on which a mark indicating the unlocked state is displayed, the display screen 850 is displayed. In other word, in the present exemplary embodiment, in a case where a menu corresponding a tab is displayed, the tab functions as a relock button. The above described transition (i.e., screen transition from the display screen 830 to the display screen 850) is a screen transition corresponding to steps S702 to S704 in FIG. 7. The display screen 850 is a display screen on which a user selects whether to lock the screen, and in response to the user pressing a “Yes” button 851, the corresponding tab, i.e., the tab 812, is changed to a locked state. In response to a “No” button 852 being pressed, the display screen 830 is displayed. As described above, the transitions are performed in this way in locking and unlocking the tab using the display screens that are displayed on the operation display unit 128.

Among known processing as print processing that is performed by printing apparatuses are processing of immediately starting print processing without receiving (accepting) authentication processing in a case where a print job is received, and reservation print processing of starting print processing after authentication processing in a case where a print job is received. In the reservation print processing, since predetermined authentication processing is performed before execution of the printing, a risk of a printing result (print product) being seen or stolen by anyone else is low, and security is high. In the configuration in which the printing apparatus 120 receives a print job from an external apparatus, such as the terminal apparatus 110, and executes the print processing, there may be a case where a user desires to set whether to perform reservation print processing when a print job is generated. For example, there may be a case where a user desires to set whether to preform reservation print processing for each print job, for example, to perform reservation print processing for a predetermined print job, and not to perform reservation print processing for a print job different from the predetermined print job. In a case where a user who uses the custom home screen “1” wants another user who uses the custom home screen “2” to execute a predetermined print job to acquire a print result, there may be a case where the user who wants the other user to acquire the print result desires to set the custom home screen to be used by the other user in accordance with the predetermined print job, in addition to the reservation print processing.

Thus, in the present exemplary embodiment, in a case where a print job is generated on the terminal apparatus 110 that transmits the print job to the printing apparatus 120, print start condition information indicating a custom home screen of the printing apparatus 120 is set as a condition to start the print execution. More specifically, in a case where the user wants to set reservation print processing for a predetermined print job, the printing apparatus 120 is configured to allow the user to set, as the print start condition, the selection of tab information corresponding to a custom home screen to be used by the user who acquires a print result of the predetermined print job. Then, the terminal apparatus 110 transmits the print job including the print start condition to the printing apparatus 120. When the printing apparatus 120 receives the print job including the print start condition of the printing apparatus 120, the printing apparatus 120 starts executing the print processing based on the print job in a case where a tab of a custom home screen corresponding to the information, which is the print start condition, indicating the custom home screen is selected.

With this configuration, since the execution of the print processing does not start until the tab corresponding to the information indicating the custom home screen included in the print job is selected, the risk of the print result (print product) being seen or stolen by anyone else is low, and the security is high. On the other hand, in a case where the print job does not include the information indicating the custom home screen, since the execution of the print processing starts in response to receipt of the print job by the printing apparatus 120, the usability is high.

Since the custom home screen is settable as the print start condition, each print job is transmitted to a user who uses the custom home screen of the user's own.

Further, as described above, in the case where the custom home screen is locked, since the execution of the print processing does not start even in a case where anyone else selects the tab corresponding to the custom home screen, the security is heightened.

Further, in the present exemplary embodiment, in generation of a print job by the terminal apparatus 110 that transmits the print job to the printing apparatus 120, a password is settable in the print job, in addition to the information indicating the custom home screen of the printing apparatus 120. In a case where the printing apparatus 120 receives the print job, the printing apparatus 120 prompts the user to input a password, and starts executing the print processing in response to matching between the input password and the password set in the print job. With this configuration, since a password is set in each print job, the security is heightened.

Even in the case where the custom home screen is locked, the printing apparatus 120 prompts the user to input the password set in the print job, not the password for releasing the lock, in the case where the password is set in the print job. In this way, for example, even in an environment in which a common password is set in the lock setting for the custom home screens, and a plurality of users knows the password to release the lock, the authentication processing for the password set in each print job is executed, which reduces chances of the print result being seen or stolen when the print processing is performed by anyone else, and accordingly, the security is heightened.

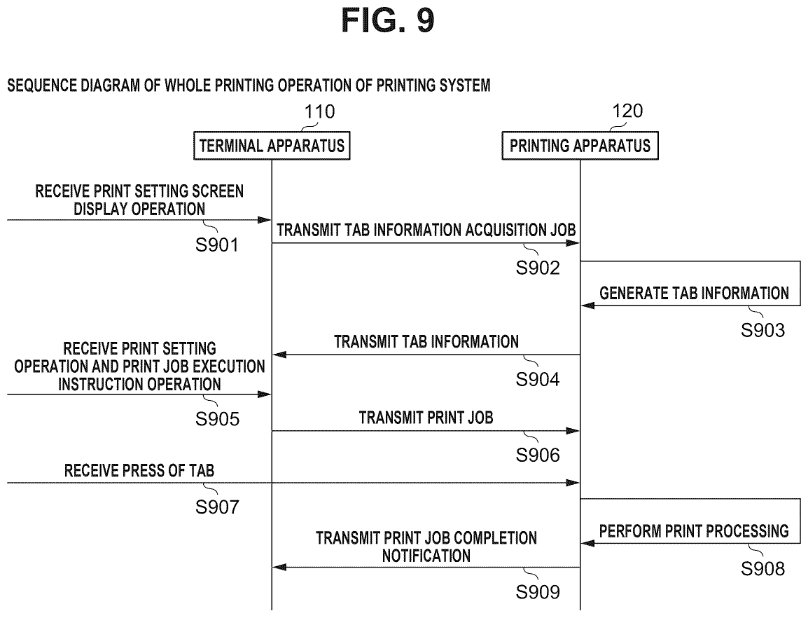

FIG. 9 is a sequence diagram of the reservation print processing in the printing system.

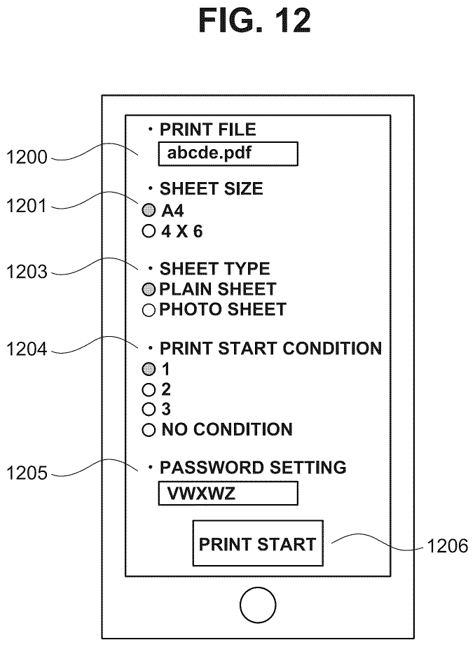

In step S901, the terminal apparatus 110 detects that a user performs an operation to display a print setting (job setting) screen on the display unit 116 of the terminal apparatus 110. In the present exemplary embodiment, a print setting screen illustrated in FIG. 12 described below is displayed, by activating a print driver of the terminal apparatus 110.

In step S902, the terminal apparatus 110 generates a tab information acquisition job to request information to be used for configuration of the print setting screen. Then, the terminal apparatus 110 transmits the generated tab information acquisition job to the printing apparatus 120 connected via the communication unit 114. Since the print driver is a unique driver for each vendor, the terminal apparatus 110 transmits a tab information acquisition request command unique to each vendor. Details of the command of the vendor driver will be described below with reference to FIG. 10.

In step S903, in response to the printing apparatus 120 receiving the tab information acquisition job, the tab information generation unit 127 refers to name information about the tabs 202, 203, and 204 stored in the RAM 123 to generate tab information.

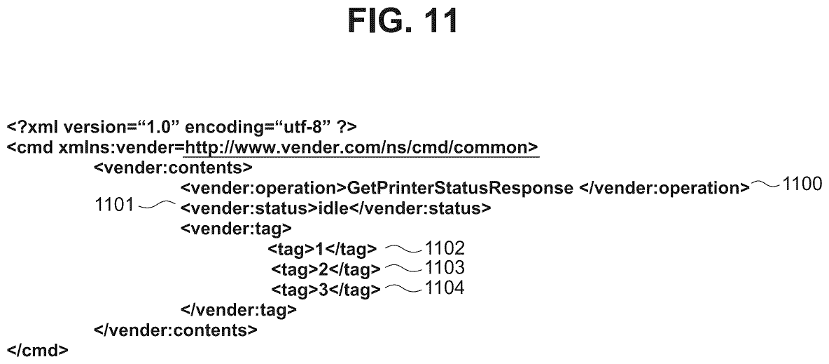

In step S904, the printing apparatus 120 transmits (responds with) the tab information generated in step S903 in FIG. 9 to the terminal apparatus 110. Details of the tab information response command of the vendor driver will be described below with reference to FIG. 11.

The terminal apparatus 110 transmits the tab information received in step S904 in FIG. 9 to the print driver, to update the print setting screen. Then, in step S905, the terminal apparatus 110 detects user's operations indicating the print setting and the print job execution instruction on the updated print setting screen. The updated print setting screen will be described below with reference to FIG. 12.

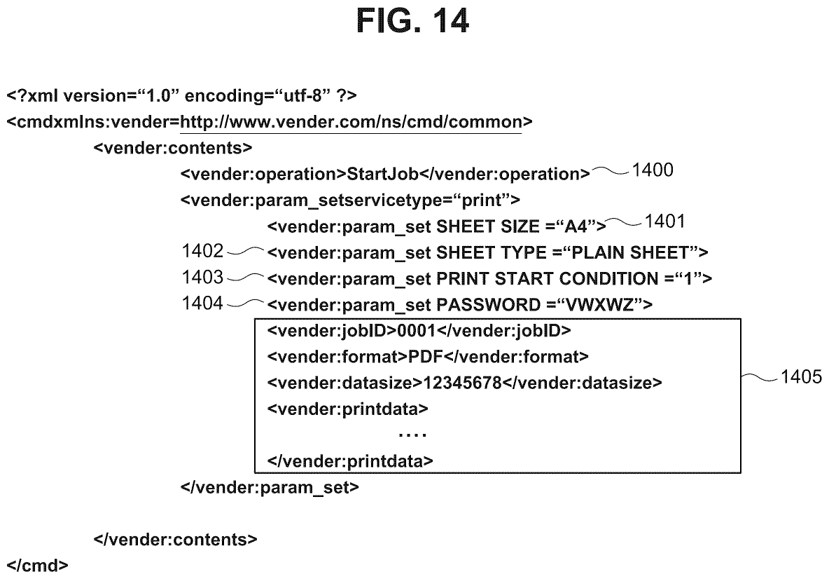

In step S906, the terminal apparatus 110 generates a print job based on the user's operations indicating the print setting and the print job execution instruction. Then, the terminal apparatus 110 transmits the generated print job to the printing apparatus 120 connected via the communication unit 114. In this processing, since the printer driver is a driver unique to each vendor, the terminal apparatus 110 generates and transmits a print job command unique to the vendor. Processing performed in generation of the print job by the terminal apparatus 110 will be described below with reference to FIG. 13. Details of the print job command of the vendor driver will be described below with reference to FIG. 14.

In response to receipt of the print job transmitted from the terminal apparatus 110 in step S906, in step S907, the printing apparatus 120 detects pressing performed on the tab of the custom home screen corresponding to the print start condition in a case where the received print job includes the print start condition. In a case where the received print job includes the password, the printing apparatus 120 displays the password input screen to receive a password input.

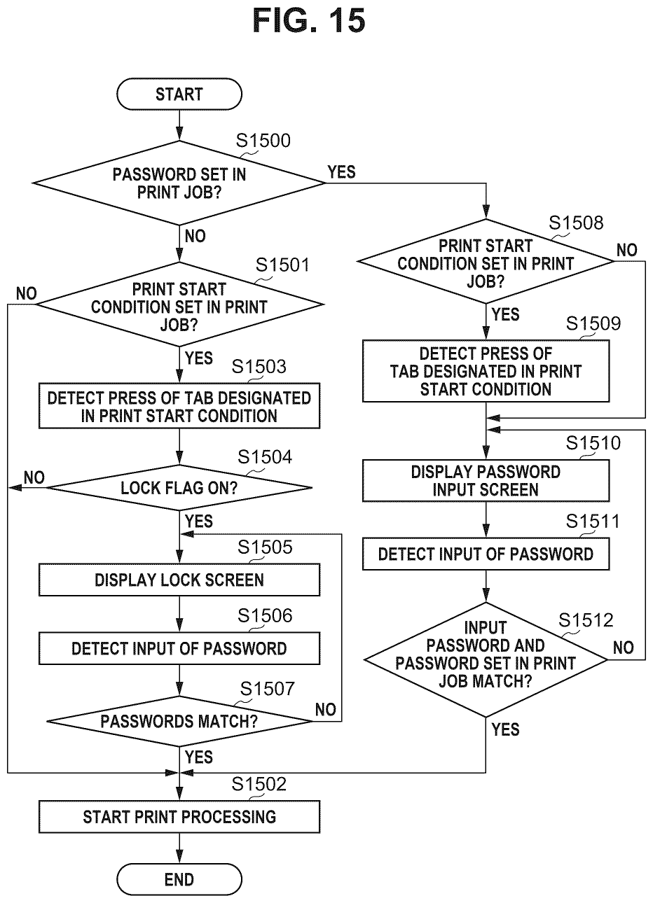

In step S908, in a case where the printing apparatus 120 receives a print job including a print start condition or a print job including the password (i.e., print job with reservation print processing set therein), the printing apparatus 120 performs the print processing on the print job in a case where pressing performed on the tab corresponding to the print start condition is detected or the authentication processing of the input password has been performed. Details thereof will be described below with reference to FIG. 15.

In a case where the printing apparatus 120 receives a print job not including the print start condition or the password (i.e., print job with no reservation print processing set therein), the printing apparatus 120 does not perform the processing in step S907. In this case, in step S908, the printing apparatus 120 analyzes the print job by the CPU 121 in response to receipt of the print job, and performs print processing.

In step S909, the printing apparatus 120 transmits a print job completion notification to the terminal apparatus 110. Details of the print job completion notification command of the vendor driver will be described below with reference to FIG. 16.

The processing in step S909 may be omitted.

While, in step S902 in FIG. 9, the terminal apparatus 110 transmits the tab information acquisition job to the printing apparatus 120 to display, on the print setting screen, the name of the tab information corresponding to the print start condition, it is not limited thereto. For example, in a case where the user cannot change the name of the tab information, the same name is always displayed on the print setting screen. Thus, the terminal apparatus 110 may display the predetermined tab information on the print setting screen, without acquiring the tab information from the printing apparatus 120.

FIG. 10 illustrates an example of the tab information acquisition request command in the printing system, described above in step S902 in FIG. 9. The tab information acquisition request command is written in Extensible Markup Language (XML), and includes a content of requesting a parameter of a tab 1001 by an operation 1000 including “GetPrinterStatus” from the printing apparatus 120. The operation 1000 is a parameter to designate a type of an operation (job), and a print job is also designated other than the “GetPrinterStatus” indicating a printer status request. The tab 1001 is a parameter to designate a tab as a parameter, and is also used to designate a parameter desired to be acquired from the printing apparatus 120, such as a sheet size, a sheet type, a sheet feed port, and a sheet discharge port, other than the tab.

FIG. 11 illustrates an example of the tab information acquisition response command in the printing system, described above in step S904 in FIG. 9. The tab information acquisition response command is written in XML, and the printing apparatus 120 generates an operation 1100 including “GetPrinterStatusResponse” for the terminal apparatus 110. The operation 1100 includes contents of a printer status 1101 including “idle”, and tab information 1102 to 1104. The printer status 1101 is a parameter to designate a printer status, and generates a status, for example, “busy” indicating that other processing is executed, or “error” indicating that the printer is in a no-sheet error status and not printable, other than the “idle” indicating printable. The tab information 1102 to 1104 each are a parameter to designate tab information, and since the names of the tabs 202, 203, and 204 of the printing apparatus 120 are “1”, “2”, and “3”, respectively, the printing apparatus 120 transmits these values as responses. For example, as is described above with reference to FIG. 2, in the case where the names of the tabs 202, 203, and 204 are “Farther”, “Mother”, and “Child”, respectively, the values transmitted as responses by the tab information 1102 to 1104 are “Farther”, “Mother”, and “Child”, respectively.

FIG. 12 is a diagram illustrating a print setting screen which is displayed on the terminal apparatus 110 described above in step S905 in FIG. 9, and via which operations to generate the print job is received. A “Print File” 1200 is an item indicating a file name (abcde.pdf) to be printed designated by a user in advance. In response to the file name part being pressed, changing to another file may be received. A “Sheet Size” 1201 is an item that receives an operation performed to designate a sheet size to be used in printing from among options. FIG. 12 illustrates a state where A4 is selected as the sheet size. A “Sheet Type” 1203 is an item that receives an operation performed to designate a sheet type to be used in printing from among options. FIG. 12 illustrates a state where a plain sheet is selected as the sheet type. A “Print Start Condition” 1204 is an item that receives an operation to designate a condition for starting to execute the print processing of the print job by the printing apparatus 120 after the terminal apparatus 110 transmits the print job to the printing apparatus 120. For the options other than “No condition”, the names of the tabs of the printing apparatus 120 acquired by the tab information acquisition response command, described above with reference to FIG. 11, are displayed. FIG. 12 illustrates a state where “1” is selected as the print start condition. In a case where the print start condition is set to “No condition”, the printing apparatus 120 starts executing the print processing immediately when the printing apparatus 120 receives the print job, which will be described below. In a case where a password is set in a “Password Setting” 1205 described below, the printing apparatus 120 executes the print processing in a case where the authentication processing with the corresponding password is successful in the printing apparatus 120. On the other hand, in a case where the print start condition is set to other than “No condition”, the printing apparatus 120 starts executing the print processing in response to the tab corresponding to the name designated as the print start condition being pressed on the printing apparatus 120. In a case where the pressed tab is locked on the printing apparatus 120, the printing apparatus 120 starts executing the print processing in response to the lock being released.

In a case where a password is set in the “Password Setting” 1205 described below, in a case where the authentication processing using the password set in the “Password Setting” 1205, not the password to release the lock setting, is successful on the printing apparatus 120, the printing apparatus 120 starts executing the print processing. The “Password Setting” 1205 is the item that receives an operation to designate a password to be used for the password authentication on the printing apparatus 120. In a case where the password is designated, the print job including the password information is transmitted to the printing apparatus 120. Then, the printing apparatus 120 performs authentication processing using the password set in the “Password Setting” 1205. On the other hand, in a case where the password is not designated, the printing apparatus 120 does not perform the authentication processing. FIG. 12 illustrates a state where the password “VWXWZ” is set. A “Print Start” button 1206 is a button to be used to instruct the start of executing the print processing, and in response to the “Print Start” button 1206 being pressed, the terminal apparatus 110 generates a print job including the print setting designated in the “Print File” 1200 to the “Password Setting” 1205. Processing by the terminal apparatus 110 after the “Print Start” button 1206 is pressed will be described below with reference to FIG. 13.

While, FIG. 12 illustrates the example in which the sheet size and the sheet type have fixed options, but they are not limited thereto. For example, the terminal apparatus 110 may request and acquire sheet size information and sheet type information supported by the printing apparatus 120 when the terminal apparatus 110 requests the acquisition of the tab information from the printing apparatus 120 using the tab information acquisition request command described above with reference FIG. 10. Then, based on the acquired sheet size information and the sheet type information, the options for the sheet size and the sheet type may be displayed on the print setting screen.

FIG. 13 is a flowchart illustrating the print job generation processing performed in the terminal apparatus 110 described above in step S905 in FIG. 9. The processing of this flowchart starts in response to pressing performed on the “Print Start” button 1206 being detected.

In step S1300, the terminal apparatus 110 sets a sheet size and a sheet type to parameters of the print job, based on the information about the “Print File” 1200 and the “Sheet Size” 1201 set on the print setting screen in FIG. 12. In the present exemplary embodiment, A4 and plain sheet are set in the parameters of the print job.

In step S1301, the terminal apparatus 110 determines whether the print start condition is set to other than “No condition”, based on the information set in the “Print Start Condition” 1204 set on the print setting screen in FIG. 12. In step S1301, in a case where the print start condition is set to other than “No condition” (YES in step S1301), the processing proceeds to step S1302. On the other hand, in a case where the print start condition is set to “No condition” (NO in step S1301), the processing proceeds to step S1303.

In step S1302, the terminal apparatus 110 sets the print start condition in the parameter of the print job. In the present exemplary embodiment, “1” is set in the parameter of the print job as the print start condition. In the case where the “Print Start Condition” 1204 is set to “No condition” (NO in step S1301), the print start condition is not set in the parameter of the print job.

In step S1303, the terminal apparatus 110 determines whether a password is set in the “Password Setting” 1205 of the print setting screen in FIG. 12. In step S1303, in a case where a password is set (YES in step S1303), the processing proceeds to step S1304. On the other hand, in a case where a password is not set (NO in step S1303), the processing proceeds to step S1305.

In step S1304, the terminal apparatus 110 sets the password in the parameter of the print job. In the present exemplary embodiment, “VWXWZ” is set in the parameter of the print job as the password. On the other hand, in the case where a password is not set in the “Password Setting” 1205 (NO in step S1303), no password is set in the parameter of the print job.

In step S1305, the terminal apparatus 110 transmits to the printing apparatus 120 the print job generated by the processing performed in steps S1300 to S1304, and ends the processing of this flowchart.

FIG. 14 illustrates an example of the print job command in the printing system described above in step S906 in FIG. 9. The print job command is written in XML, and includes four print parameters 1401 to 1404 and print data 1405 in an operation 1400 “StartJob” for the printing apparatus 120. In the four print parameters 1401 to 1404, the parameter 1401 of the sheet size is set to “A4”, the parameter 1402 of the sheet type is set to “plain sheet”, the parameter 1403 of the print start condition is set to “1”, and the parameter 1404 of the password is set to “VWXWZ”. In the print data 1405, JobID is set to “0001”, the format of the print data is set to “PDF”, the data size is set to “12345678”, and actual print data is set in a portion between <vender: printdata> tags. The parameter 1403 of the print start condition is set (included) in a case where the terminal apparatus 110 determines in step S1301 that the parameter other than “No condition” is set in the print start condition (YES in step S1301), and the terminal apparatus 110 sets the parameter 1403 of the print start condition in the parameter of the print job in step S1302 in FIG. 13. In step S1301, in the case where the terminal apparatus 110 determines that “No condition” is set in the print start condition (NO in step S1301), the parameter 1403 of the print start condition is not set (included). Similarly, the parameter 1404 of the password is set, in the case where the terminal apparatus 110 determines in step S1303 that the password is not set (NO in step S1303), and the terminal apparatus 110 sets the password in the parameter 1404 of the print job in step S1304 in FIG. 13. In the case where the terminal apparatus 110 determines in step S1303 that the password is not set (NO in step S1303), the parameter 1404 of the password is not included.

FIG. 15 is a flowchart illustrating the execution processing of the print job that is performed by the printing apparatus 120 described above in step S908 in FIG. 9. The processing of this flowchart starts in response to receipt of the print job from the terminal apparatus 110.

In step S1500, the printing apparatus 120 determines whether a password is set in the parameter of the print job. More specifically, the printing apparatus 120 determines whether the parameter 1404 of the password is set in the parameter of the print job in FIG. 14. In a case where the printing apparatus 120 determines that the parameter 1404 of the password is set in the parameter of the print job in FIG. 14 (YES in step S1500), the processing proceeds to step S1508. On the other hand, in a case where the printing apparatus 120 determines that the parameter 1404 of the password is not set in the parameter of the print job in FIG. 14 (NO in step S1500), the processing proceeds to step S1501. The printing apparatus 120 displays “Now printing.” on the operation display unit 128 in response to the start of the processing of this flowchart, and the printing apparatus 120 disables receipt of the other operations.

In step S1501, the printing apparatus 120 determines whether the print job includes information indicating the print start condition. More specifically, the printing apparatus 120 determines whether the parameter 1403 of the print start condition is set in the parameter of the print job in FIG. 14. In step S1501, in a case where the printing apparatus 120 determines that the print job includes the information indicating the print start condition (YES in step S1501), the processing proceeds to step S1503. On the other hand, in step S1501, in a case where the printing apparatus 120 determines that the print job does not include the information indicating the print start condition (NO in step S1501), the processing proceeds to step S1502.

In step S1502, the printing apparatus 120 executes the print processing based on the information about the print job, and ends the processing of this flowchart.

In step S1503, the printing apparatus 120 displays a screen like a screen including tabs that is to switch the home screens, and are displayed at the upper part of each of the home screens in FIGS. 2, 3A, and 3B, to detect that the tab designated as the print start condition is pressed by a user. For example, in a case where the print job includes information indicating the print start condition “1”, the printing apparatus 120 detects pressing performed on the tab 202 indicating the custom home screen “1”. In step S1503, the processing is suspended until the pressing performed on the tab designated in the print start condition is detected. The print job may be deleted when a predetermined time has elapsed before detection of pressing on the tab designated in the print start condition from when the printing apparatus 120 has received the print job.

In step S1504, the printing apparatus 120 determines whether the tab designated in the print start condition is locked. More specifically, the printing apparatus 120 acquires the value of the tab lock flag designated in the print start condition from the RAM 123 and determines whether the lock flag is ON. In a case where the printing apparatus 120 determines that the lock flag is not ON (NO in step S1504), the printing apparatus 120 display an initial screen (menu screen) of the custom home screen corresponding to the pressed tab, then, advances the processing to step S1502, and ends the processing of this flowchart. On the other hand, in a case where the printing apparatus 120 determines that the lock flag is ON (YES in step S1504), the processing proceeds to step S1505.

In step S1505, the printing apparatus 120 displays the lock screen illustrated in FIG. 4 (or display screen 810 illustrated in FIG. 8) described above.

In step S1506, in response to the printing apparatus 120 detecting pressing performed on the unlock button 813 by the user on the display screen 810 illustrated in FIG. 8 described above, the printing apparatus 120 displays the display screen 820 serving as the password input screen to detect the password input from the user.

In step S1507, the printing apparatus 120 performs authentication processing based on the input password. More specifically, the printing apparatus 120 determines whether the input password and the password set in the lock setting match. In step S1507, in a case where the printing apparatus 120 determines that the passwords match (YES in step S1507), the printing apparatus 120 sets the lock flag to OFF, displays an initial screen (menu screen) of the custom home screen corresponding to the pressed tab, advances the processing to step S1502, and then ends the processing of this flowchart. On the other hand, in step S1507, in a case where the printing apparatus 120 determines that the passwords do not match (NO in step S1507), the printing apparatus 120 returns the processing to step S1505, and displays the lock screen again.

In step S1508, which is a step to which the processing proceeds in the case where the printing apparatus 120 determines in step S1500 that the password is set in the parameter of the pint job in FIG. 14, the printing apparatus 120 determines whether the print job includes the information indicating the print start condition. More specifically, the printing apparatus 120 determines whether the parameter 1403 of the print start condition is set in the parameter of the print job in FIG. 14. In step S1508, in a case where the printing apparatus 120 determines that the parameter 1403 of the print start condition is set (YES in step S1508), the processing proceeds to step S1509. On the other hand, in step S1501, in a case where the printing apparatus 120 determines that the parameter 1403 of the print start condition is not set (NO in step S1501), the processing proceeds to step S1510.

In step S1509, the printing apparatus 120 displays any one of the home screens including the tabs displayed at the upper part of each of the home screens illustrated in FIGS. 2, 3A, and 3B, and detects pressing performed on the tab designated by the user as the print start condition. For example, in a case where the print job includes the information indicating the print start condition “1”, the printing apparatus 120 performs detection of pressing performed on the tab 202 indicating the custom home screen “1”. In step S1509, the processing is stopped until pressing performed on the tab designated in the print start condition is detected. The print job may be deleted in a case where a predetermined time has elapsed before detection of pressing on the tab designated as the print start condition from when the printing apparatus 120 has received the print job.

In step S1510, the printing apparatus 120 displays the display screen 820 serving as the password input screen illustrated in FIG. 8 on the operation display unit 128.

In step S1511, the printing apparatus 120 detects the password input by the user on the display screen 820.

In step S1512, the printing apparatus 120 performs authentication processing based on the input password. More specifically, the printing apparatus 120 determines whether the input password and the password included in the print job match. In step S1512, in a case where the input password and the password included in the print job match (YES in step S1512), the printing apparatus 120 displays an initial screen (menu screen) of the custom home screen corresponding to the pressed tab, advances the processing to step S1502, and then ends the processing of this flowchart. On the other hand, in step S1512, in a case where the input password and the password included in the print job do not match (NO in step S1512), the printing apparatus 120 returns the processing to step S1510, to display the display screen 820 again on the operation display unit 128.

In the flowchart in FIG. 15 described above, the processing in steps S1510 to S1512 may be performed before the processing in steps S1508 and S1509. More specifically, the printing apparatus 120 may display, on the operation display unit 128, the display screen 820 serving as the password input screen illustrated in FIG. 8, in the case where the printing apparatus 120 has determined that the password is set in the parameter of the print job in step S1500 (YES in step S1500). Then, the printing apparatus 120 may start executing the print processing, in a case where the authentication processing based on the input password is completed, and when the printing apparatus 120 detects pressing performed on the tab designated by the user as the print start condition, from among the tabs displayed at the upper part of each of the home screens illustrated in FIGS. 2, 3A, and 3B.

FIG. 16 illustrates an example of the print job response command in the printing system, described above in step S909 in FIG. 9. The print job response command is written in XML, and the printing apparatus 120 generates an operation 1600 “StartJobResponse” for the terminal apparatus 110. The operation 1600 includes a content of result information 1601 indicating “OK” of the print job. The result information 1601 is a parameter for a notification of a result of the print job, and the printing apparatus 120 generates, for example, parameters such as “cancel” indicating that the printing is canceled, and “NG” indicating that the printing is impossible because of the no-sheet error state, other than “OK” indicating that the printing is successfully completed.

As described above, in the present exemplary embodiment, the terminal apparatus 110 sets the information indicating the custom home screen of the printing apparatus 120 as the condition to start the print execution in generation of the print job by the terminal apparatus 110 that transmits the print job to the printing apparatus 120. More specifically, in a case where a user wants to set the reservation print processing in a predetermined print job, the user sets, in the print start condition, a selection of the tab information about the custom home screen to be used by the user who wants to acquire a print result of the predetermined print job. Then, the terminal apparatus 110 transmits the print job including the print start condition to the printing apparatus 120. In a case where the printing apparatus 120 receives the print job including the print start condition of the printing apparatus 120, the printing apparatus 120 starts executing the print processing based on the print job in response to the tab of the custom home screen corresponding to the information indicating the custom home screen, which is the print start condition, being selected.

In this way, since the execution of the print processing does not start until when the tab corresponding to the information indicating the custom home screen included in the print job is selected, the risk of the print result (print product) being seen or stolen by anyone else is low, and the security is high. On the other hand, in the case where the print job does not include the information indicating the custom home screen, since the execution of the print processing starts based on a fact that the print job by the printing apparatus 120 is received, the usability is high.

In the above-described exemplary embodiment, in a case where the printing apparatus 120 has first authentication processing for releasing the lock setting settable for each of the tabs 202, 203, and 204 corresponding to the respective custom home screens, and second authentication processing that is performed based on the second password set in the print job by the terminal apparatus 110, the second authentication processing is prioritized. However, it is not limited thereto. The printing apparatus 120 may be controlled to prioritize the first authentication processing over the second authentication processing. More specifically, in the flowchart in FIG. 15, in a case where the processing in steps S1500, S1508, and S1509 is omitted, the determination in step S1504 is NO, the processing may proceed to step S1510, and the display screen 820 serving as the password input screen may be displayed for the second authentication processing (i.e., processing in steps S1511 and S1512). Based on that any one of the passwords is input, the authentication processing corresponding to the input password may be performed, or both the first authentication processing and the second authentication processing may be performed.

With the configuration in which the custom home screen is settable as the print start condition, the print job is transmitted to the user who uses the custom home screen of the user's own.

Further, as described above, in the state where the custom home screen is locked, even in a case where anyone else selects the tab corresponding to the custom home screen, execution of the print processing does not start, and thus the security is heightened.

Further, in the present exemplary embodiment, in generation of a print job by the terminal apparatus 110 that transmits the print job to the printing apparatus 120, the terminal apparatus 110 is configured to set a password in the print job, in addition to the information indicating the custom home screen of the printing apparatus 120. Then, in response to receipt of the print job, the printing apparatus 120 prompts the user to input the password, and starts executing the print processing based on that the input password and the password set in the print job match. Even in the state where the custom home screen is locked, in the case where the password is set in the print job, the printing apparatus 120 prompts the user to input the password set in the print job, not the password for releasing the lock.

With the above-described configuration, since a password is set in each print job, the security is heightened. For example, even in an environment in which a common password is set in the lock setting for each custom home screen, and a plurality of users knows the password to release the lock, as long as a password is set in each print job, chances of the print result being seen or stolen by the print processing being performed by anyone else are reduced, and thus, the security is heightened.

Even in the state where the custom home screen is locked, in the case where the password is set in the print job, the printing apparatus 120 prompts the user to input the password set in the print job, not the password for releasing the lock. With this configuration, as described above, even in the environment in which a plurality of users knows the password to release the lock, chances of the print result being seen or stolen by the print processing being performed by anyone else are reduced, which heightens the security.

While, in the exemplary embodiment described above, “Now printing.” is displayed on the operation display unit 128, and the printing apparatus 120 is in an occupied state when the printing apparatus 120 has received the print job, it is not limited thereto. For example, in a case where the printing apparatus 120 has a large-capacity storage apparatus, such as a hard disk drive (HDD), the received print job may be temporarily stored in the HDD, and the printing apparatus 120 may accept the other operations until the tab corresponding to the print start condition is pressed. Alternatively, in a case where the printing apparatus 120 does not have a large-capacity storage apparatus, such as an HDD, the print job command described with reference to FIG. 14 may be received in two stages separately. More specifically, in step S906, the printing apparatus 120 may receive and store information other than the print data 1405 with a large data amount, and in a case where the tab corresponding to the print start condition is pressed, the printing apparatus 120 may receive the remaining information in the print job command to start executing the print processing. In this way, even with the printing apparatus 120 not having a large-capacity storage apparatus, such as an HDD, since the printing apparatus 120 starts executing the print processing based on that the tab corresponding to the print start condition is pressed, the other operations are receivable until the tab corresponding to the print start condition is pressed. Examples of the other operations include operations of other tabs (e.g., tabs 201, 203, and 204 when the print start condition is “1”) being selected, not the detection of pressing performed on the tab designated in the print start condition in step S1503 in FIG. 15. In a case where one of the other tabs is selected, the printing apparatus 120 may display a default screen that is displayed in response to pressing performed on the other tab. More specifically, an initial screen (menu screen) corresponding to the pressed tab may be displayed. Each of the screens displayed on the operation display unit 128 in the flowchart in FIG. 15 may include softkeys for accepting other operations (e.g., tabs 201, 202, 203, and 204 may be displayed on the display screen 820 serving as the password input screen), or the printing apparatus 120 may be provided with a hardware key to return the screen to the default (standard) home screen.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-208657, filed Dec. 11, 2023, which is hereby incorporated by reference herein in its entirety.

What is claimed is:

1. An image processing apparatus having a plurality of home screens, comprising:
a reception unit configured to receive job information about a job based on a job setting set on an information processing apparatus; and
an acceptance unit configured to accept, based on a fact that the job information received by the reception unit includes start condition information that is information relating to a home screen among the plurality of home screens and indicating a condition for starting processing based on the job information, an input of start condition information.

2. The image processing apparatus according to claim 1, wherein in a case where the start condition information included in the job information received by the reception unit and the input of the start condition information accepted by the acceptance unit match, the image processing apparatus starts processing the job based on the job information.

3. The image processing apparatus according to claim 1, wherein in a case where the job information received by the reception unit does not include the start condition information, the image processing apparatus starts processing the job, based on a fact that the job information by the reception unit is received.

4. The image processing apparatus according to claim 1, wherein in a case where the job information received by the reception unit includes password information, the acceptance unit accepts an input of a password set in the job information before the image processing apparatus starts processing the job.

5. The image processing apparatus according to claim 4, wherein in a case where the password of which input has been accepted by the acceptance unit and the password information included in the job information match, the image processing apparatus starts processing the job based on the job information.

6. The image processing apparatus according to claim 1, further comprising:
a lock function setting unit configured to set a lock function for each of the plurality of home screens,
wherein the acceptance unit accepts, based on a fact that the lock function for the home screen corresponding to the start condition information is enabled by the lock function setting unit, and the acceptance unit has accepted the input of the start condition information, an input of a password for release of the lock function before the image processing apparatus starts processing the job.

7. The image processing apparatus according to claim 6, wherein in a case where the password for release of the lock function of which input has been accepted by the acceptance unit, and the password information set by the lock function setting unit match, the image processing apparatus starts processing the job, based on the job information.

8. The image processing apparatus according to claim 6,
wherein in a case where the lock function for the home screen corresponding to the start condition information is enabled by the lock function setting unit, and the password information is included in the job information received by the reception unit, the acceptance unit accepts the input of the password set in the job information before the image processing apparatus starts processing the job, and
wherein in a case where the password and the password information included in the job information match, the image processing apparatus starts processing the job, based on the job information.

9. The image processing apparatus according to claim 1, further comprising:
a display unit configured to display the plurality of home screens and software keys each for displaying a different one of the plurality of home screens, and
wherein the acceptance unit accepts an input of a software key to display the home screen corresponding to the start condition information as an input of the start condition information from among the plurality of home screens.

10. The image processing apparatus according to claim 4, further comprising:
a display unit configured to display a password input screen for accepting the input of the password,
wherein the acceptance unit accepts the input of the password on the password input screen.

11. A control method for an image processing apparatus having a plurality of home screens, comprising:
receiving job information about a job based on a job setting set on an information processing apparatus; and
accepting, based on a fact that the job information received by the receiving includes start condition information that is information relating to a home screen among the plurality of home screens and indicating a condition for starting processing based on the job information, an input of start condition information.

12. A non-transitory computer-readable storage medium storing a program that causes a computer of an image processing apparatus having a plurality of home screens to perform:
receiving job information about a job based on a job setting set on an information processing apparatus; and
accepting, based on a fact that the job information received by the receiving includes start condition information that is information relating to a home screen among the plurality of home screens and indicating a condition for starting processing based on the job information, an input of start condition information.
